(19) United States
(12) Patent Application Publication
(10) Pub. No.: US 2009/0140142 A1
(43) Pub. Date: Jun. 4, 2009

(54) SCANNING PROBE MICROSCOPE AND MEASURING METHOD THEREBY

(76) Inventor: Ken Murayama, Ibaraki (JP)

Correspondence Address: MATTINGLY & MALUR, P.C., 1800 DIAGONAL ROAD, SUITE 370, ALEXANDRIA, VA, 22314, US

(21) Appl. No.: 11/816,870

(22) PCT Filed: Feb. 22, 2006
(86) PCT No.: PCT/JP2006/303142

§ 371 Date: Nov. 25, 2008

(30) Foreign Application Priority Data
Feb. 23, 2005 (JP) 2005-047858

(51) Int. Cl. G01N 23/00

(52) U.S. Cl. 250/307; 250/306

(57) ABSTRACT

A scanning probe microscope performs first scanning movement of a probe in X and Y directions along a sample surface while controlling the position of the probe in a Z direction by an XYZ fine movement mechanism. Measurement information about the sample surface is obtained by a measurement section and displacement detection section during the first scanning. A probe movement path is determined for a second scanning that includes a measuring spot in which a measurement including a parallel direction component to the sample surface to be performed on the probe movement path is determined, on the basis of the measurement information about the sample surface. As a result of performing the measurement including the parallel direction component based on the second scanning wear of the probe is reduced and measurement reliability and simplified movement control of the scanning of the probe is enabled.

### TECHNICAL FIELD

The present invention relates to a scanning probe microscope and a measuring method thereby, more particularly, relates to a scanning probe microscope suitable for form measurement and size measurement about forms, etc. having sidewalls or slopes, and a measuring method performed by the scanning probe microscope.

### BACKGROUND ART

A scanning probe microscope has been conventionally well known as a measurement unit with a measurement resolution enabling observation of fine objects of the atom order or size. In recent years, scanning probe microscopes have been applied to a variety of fields such measurement of the fine relief or uneven shapes of the surface of a substrate or wafer on which semiconductor devices are formed. There are various types of scanning probe microscopes designed for different physical quantities for detection utilized for measurement. For example, there are scanning tunnel microscopes (STM) utilizing the tunnel current, atomic force microscopes (AFM) utilizing atomic force, magnetic force microscopes (MFM) utilizing magnetic force and the like. The range of their application is also growing.

In the above scanning probe microscopes, the atomic force microscopes are suitable for detecting the fine relief shapes of a sample surface at a high resolution and are used in the field of semiconductor production technology, etc.

An atomic force microscope has a part of measurement unit for performing a measurement based on the principle of atomic force microscopes as a basic configuration. Usually, the atomic force microscope has a tripod type or tube type XYZ fine movement mechanism formed by piezoelectric elements. At the bottom end of the XYZ fine movement mechanism, a cantilever with a probe formed at its front end is attached. The tip of the probe is pointed to the surface of the sample. The above cantilever is provided with an optical lever type photo detection device, for example. That is, a laser beam emitted from a laser beam source (laser oscillator) disposed above a cantilever is reflected at the back surface of the cantilever and detected by a photo detector. If twisting or bending occurs in the cantilever, the position on the light-receiving surface of the photo detector on which the laser beam strikes will change. Therefore, if displacement occurs in the probe and cantilever, it is possible to detect the direction and amount of the displacement by the detection signal output from the photo detector.

Regarding the configuration of the above atomic force microscope, it is normally provided with a comparator and a controller as a control system. The comparator compares the detection voltage signal output from the photo detector and the reference voltage, and outputs an error signal. The controller generates a control signal so that the error signal becomes 0 and gives this control signal to the Z-fine movement mechanism in the XYZ fine movement mechanism. In this way, a feedback servo control system for maintaining the distance between the sample and the probe at a certain distance is formed. Due to the above configuration, the probe can be made to follow along and scan fine relief shapes etc. on the sample surface, and the shapes etc. can be measured.

The atomic force microscope used for measuring semiconductor wafers has the AFM system controller that can automatically perform a series of processes such as determination of observation places, measurements by AFM, processing of data obtained by the AFM measurements and the like.

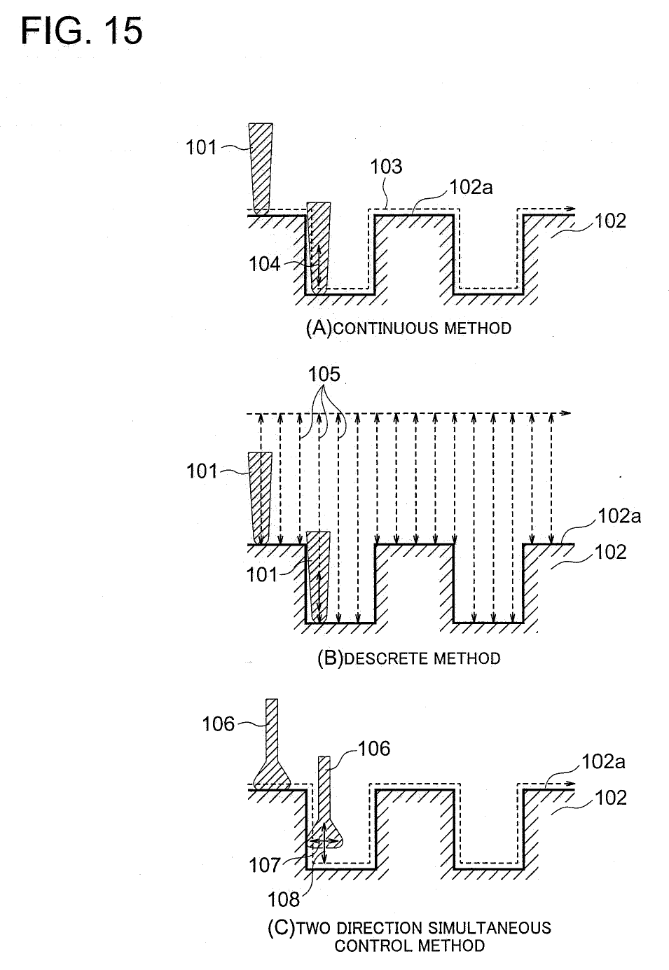

Here, a conventional and general method of moving the probe for a scanning operation is explained with reference to FIG. 15, and conventional problems are pointed out. In FIG. 15, 101 designates the probe, 102 designates a sample and 102a designates a sample surface.

FIG. 15(A) shows a continuous method for moving the probe continuously. In the continuous method, the probe 101 is moved along with the sample surface 102a to trace it continuously. A broken line 103 indicates movement locus of the tip part of the probe 101. Two methods are generally used for the continuous methods. One method (a static contacting method) is of making the probe to be scanned in the directions (X and Y directions) of the sample surface while keeping a bend of the cantilever to be a constant static state, and another method (a dynamic contacting method: Patent Document 1 is referred) is of detecting an oscillating amplitude and an oscillation number shift due to an atomic force by minutely oscillating the cantilever (the probe) at a resonant point of the cantilever. Fundamentally, a control direction of the probe 101 is only a height direction (the Z direction) in the sample surface 102a as shown by an arrow 104. The continuous method cannot measure the side form of the trench formed on the surface of the sample 102, which has a right-angled wall surface, because of restrictions due to the tip radius or tip angle of the probe 101 as shown in FIG. 15 (A). Moreover, it also has the problem that wear becomes large at the tip of the probe 101, because it uses a system that traces the sample surface 102a continuously. In case of measuring the surface having steep inclination parts, especially, the probe 101 cannot follow the form of the inclination parts, and the wear of the probe 101 becomes larger. Therefore, the continuous method has the problem that it is not suitable for the measurement of the steep inclination parts of the sample surface.

FIG. 15(B) shows a discrete (discontinuous) method for moving the probe discretely (Patent Document 2 is referred). In the discrete method, as shown by a lot of broken or dotted lines 105 in the figure, the probe 101 is approached to the sample surface 102a at only measuring points in which the measurement of the surface form is performed on the sample surface 102a, while the probe 101 is separated from the sample surface 102a when doing the scanning movement to the X and Y directions. It is also difficult for the discrete method to measure the side form of the sheer wall with an angle of 90° accompanying with the shape of the probe 101 like the continuous method. However, the discrete method can reduce the wear of the probe 101 because a lateral force accompanying with the scanning movement of the probe does not act in the probe, and a contact time between the probe and the sample surface is short. Therefore, the discrete method has been used in the technical field in which the high reliable measurement is requested, such as the in line inspection use of a semiconductor and the like.

FIG. 15(C) shows an example of the two direction simultaneous control method (Patent Document 3 is referred). The probe 106, which has a spread part with a shape widen toward the end in its tip part, is controlled to move in two directions of the horizontal (lateral) direction (X direction: an arrow 107) and perpendicular (longitudinal) direction (Z direction: an arrow 108) directions in FIG. 15 (C). In accordance with the two direction simultaneous control method, the tip part of the probe 106 is vibrated in the X and Y directions and controlled to make vibration amplitudes and frequency changes to become fixed, and thereby the method enables to carry out the measurement of side walls such as trenches and the like formed on the sample surface. However, since the above method fundamentally has a feature that the probe continuously traces the uneven shapes of the sample surface 102a, the large wear of the probe 106 is not improved.

Moreover, since the two direction simultaneous control needs the horizontal direction vibration (the arrow 107), it has the restriction about the measurable width of the trenches. When setting “d” to be a diameter of the probe tip, “a” to be a vibration amplitude, and “W” to be a width of the trench, it is necessary that the relation of W>d+a is satisfied. With the advance of minimizing semiconductor devices, the trench width (or hole diameter) is more made to be minute and presently the size of 30-60 nm is being required. The size of 20 nm is the present technical limit, and when the diameter of the probe is made to become small excessively, the probe becomes easy to be bent and has the limit of utilization in an aspect of rigidity. Furthermore, it is thought that the amplitude of the horizontal direction vibration needs the dozens of nm (nanometers) at least. As mentioned above, the system that needs the horizontal direction vibration is disadvantageous in an aspect of minimizing samples. Furthermore, in order to continuously trace the surface of the sample with the trenches, it is always necessary to trace a right and left both-sides wall in the trench, and therefore, the control for moving the probe becomes complicated, and there arises the problem that a measurement time becomes long.

Patent Document 1: The U.S. Pat. No. 2,732,771 (JP-A-7-270434)

Patent Document 2: The U.S. Pat. No. 2,936,545 (JP-A-2-5340)

Patent Document 3: The U.S. Pat. No. 2,501,282 (JP-A-6-82248)

### SUMMARY OF THE INVENTION

### The Problem to be Solved by the Invention

In case of measuring uneven shapes and the like on the surface of the sample by the scanning probe microscope in accordance with the conventional probe movement methods, the following problems arise. That is, when measuring the slope portions and side walls, etc., such as minute trenches and holes, in the uneven or rough shape on the sample surface, the wear of the tip part of the probe occurs seriously, the measurement reliability becomes low as a result, and also the movement control for the scanning operation of the probe becomes complicated, and the scanning time for the measurement becomes long as a whole.

An object of the present invention is to provide a scanning probe microscope and measurement method thereby capable of decreasing the wear of the tip part of the probe, raising the reliability of the measurement, easily carrying out the movement control for the scanning operation of the probe, and scanning the probe on the sample surface in a short time, when measuring the slope portions and side walls, etc., in minute trenches and holes on the sample surface.

### The Means for Solving the Problem

A scanning probe microscope and measurement method thereby in accordance with the present invention is constituted as follows, in order to attain the above-mentioned object.

A measuring method of a scanning probe microscope of the present invention is applied to the scanning probe microscope having a cantilever with a probe being opposite to a sample, a XYZ fine movement mechanism for making displacement in each direction of three axes (two axes X and Y parallel to a sample surface and an axis Z of a height direction to the sample surface) which intersect perpendicularly in a positional relationship between said probe and the sample, a movement mechanism for changing a relative position of the probe and the sample, a measurement section for measuring surface properties of the sample based on the physical amount generated between the probe and the sample when making the probe scan the sample surface, and a displacement detection section for detecting the displacement of the cantilever. In the scanning probe microscope, the surface characteristic of the sample is measured by making the probe scan the sample surface while holding the physical amount to be constant. The measuring method comprises a first step of performing a first time scanning movement of the probe in both or either of X and Y directions along a surface of the sample while controlling the position of the probe in a Z direction on the sample according to a predetermined probe movement path by the movement mechanism and the XYZ fine movement mechanism, a second step of obtaining measuring information about the surface of the sample by the measurement section and the displacement detection section during the first step, a third step of determining a probe movement path for a second time scanning and a measuring spot in which a measurement including a parallel direction component to the surface of the sample is performed on the probe movement path, on the basis of the measuring information about the surface of the sample obtained in the second step, and a fourth step of performing the measurement including the parallel direction component based on the second time scanning.

In the measuring method of a scanning probe microscope, preferably, the measuring spot in which the measurement including the parallel direction component to the surface of the sample is performed has a spot having a slope on the surface of the sample.

In the measuring method of a scanning probe microscope, preferably, the probe is separated from the surface of the sample in an area except for the measuring spot in the surface of the sample in the probe movement path based on the scanning movement.

In the measuring method of a scanning probe microscope, preferably, the probe has pointed ends directed to both or either of parallel and perpendicular directions to the surface of the sample.

In the measuring method of a scanning probe microscope, preferably, the probe is disposed so that an axis of the probe is inclined to the surface of the sample.

In the measuring method of a scanning probe microscope, preferably, the measurement including the parallel direction component to the surface of the sample in the fourth step is performed at one measuring point at least or required minimum measuring points, in which size measurement is required.

In the measuring method of a scanning probe microscope, preferably, the measurement including the parallel direction component to the surface of the sample uses a torsion signal generated when the cantilever is twisted.

In the measuring method of a scanning probe microscope, preferably, when the surface of the sample is formed to have trenches, the measurement including the parallel direction component to the surface of the sample in the fourth step is performed to be parallel to the trenches.

In the measuring method of a scanning probe microscope, preferably, when the surface of the sample is formed to have holes, the measurement including the parallel direction component to the surface of the sample in the fourth step is performed to be along a circumference direction of the holes.

In the measuring method of a scanning probe microscope, preferably, when performing the first step and the fourth step in a going and returning scanning movement, the first step is performed in the going path and the fourth step is performed in the returning path.

In the measuring method of a scanning probe microscope, preferably, the scanning movement in the fourth step is performed against the surface of the sample, based on the measuring information about the surface of the sample obtained by the first and second steps so that a movement direction at each of measuring points is along a normal direction of the sample surface.

In the measuring method of a scanning probe microscope, preferably, further, the method provides a fifth step of composing the measurement information obtained by the second step and the measurement information obtained by the fourth step.

In the measuring method of a scanning probe microscope, preferably, both or either of a torsion signal and a flexure signal in the cantilever is used for detecting contact between the probe and the sample in the measurement including the parallel direction component based on the fourth step.

In the measuring method of a scanning probe microscope, preferably, a first scanning performed in the first step is one line scanning of X direction (or Y direction), and a probe movement path and a measurement spot determined in the third step is made by repeatedly shifting a probe movement path and a measurement spot determined on the basis of information obtained by the second step to the Y direction (or X direction).

In the measuring method of a scanning probe microscope, preferably, one point or several points are selected as points for obtaining measurement information during the first scanning in said second step, the probe movement path determined in said third step is a straight line determined by the measurement information obtained at one point or several points, and the measurement including the parallel direction component to the sample surface in the fourth step is performed along the straight line.

A scanning probe microscope of the present invention is provided with a cantilever with a probe which is opposite to a sample, a XYZ fine movement mechanism for making displacement in each direction of three axes (two axes X and Y parallel to a sample surface, and an axis Z of a height direction to the sample surface) which intersect perpendicularly in a positional relationship between the probe and the sample, a movement mechanism for changing a relative position of the probe and the sample, a measurement section for measuring surface properties of the sample based on the physical amount generated between the probe and the sample when making the probe scan the surface of the sample, and a displacement detection section for detecting the displacement of the cantilever, and a control computer for changing a positional relationship between the probe and the sample by the XYZ fine movement mechanism and the movement mechanism. By the above structure, the surface characteristic of the sample can be measured by making the probe scan the surface of the sample while holding the physical amount to be constant. In the scanning probe microscope of the present invention, the control computer is installed with a program for realizing a first function for performing a first time scanning movement of the probe in both or either of X and Y directions along a surface of the sample while controlling the position of the probe in a Z direction on the sample according to a predetermined probe movement path by the movement mechanism and the XYZ fine movement mechanism, a second function for obtaining measuring information about the surface of the sample by the measurement section and the displacement detection section during the scanning, a third function for determining a probe movement path for a second time scanning and a measuring spot in which a measurement including a parallel direction component to the surface of the sample is performed on the probe movement path, on the basis of the measuring information about the surface of the sample obtained in the measurement, and a fourth function for performing the measurement including the parallel direction component based on the second time scanning.

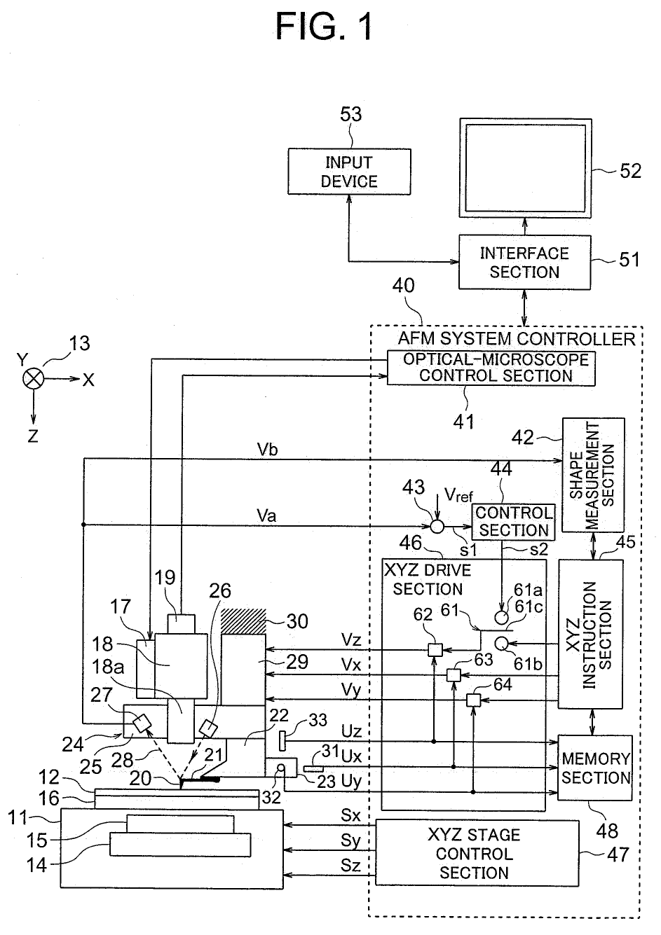

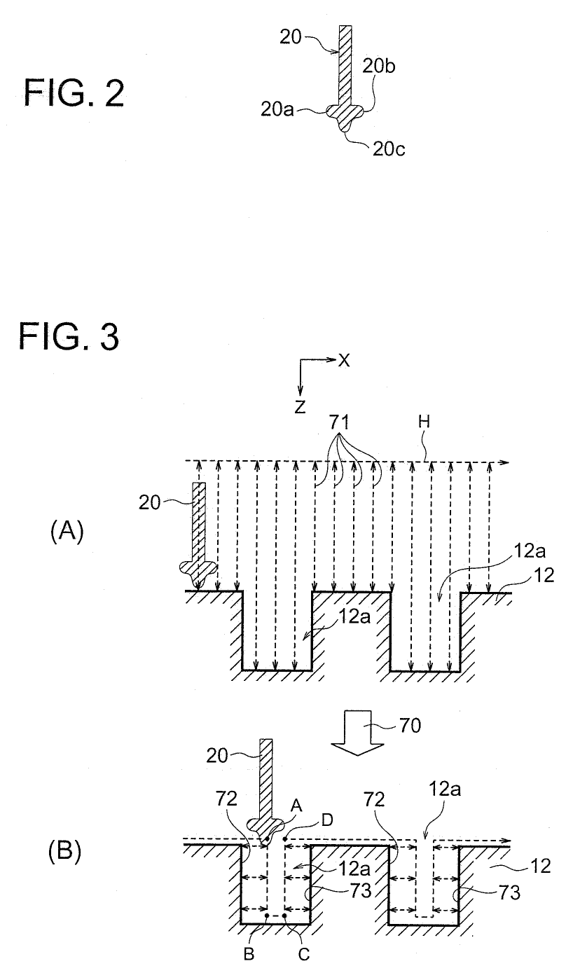

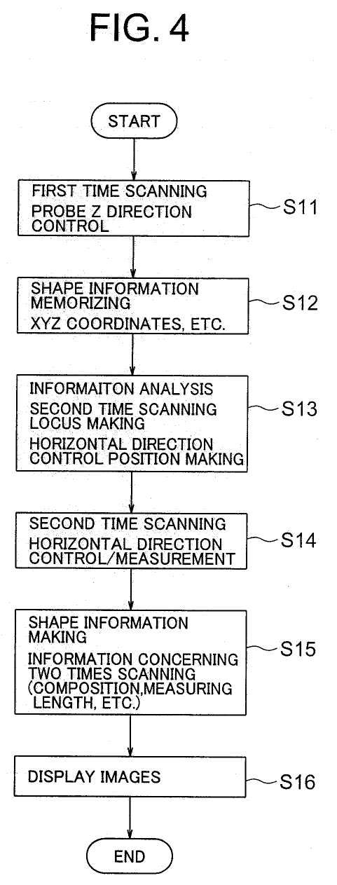

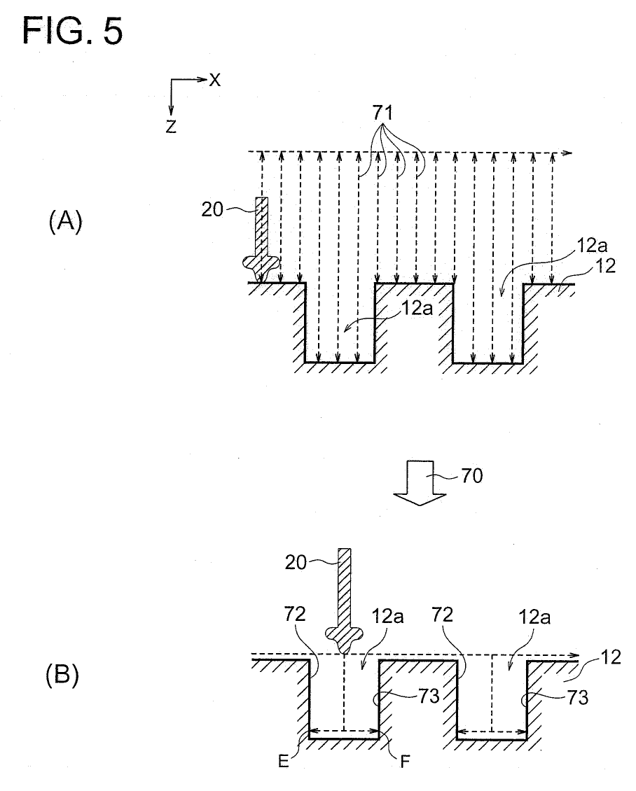

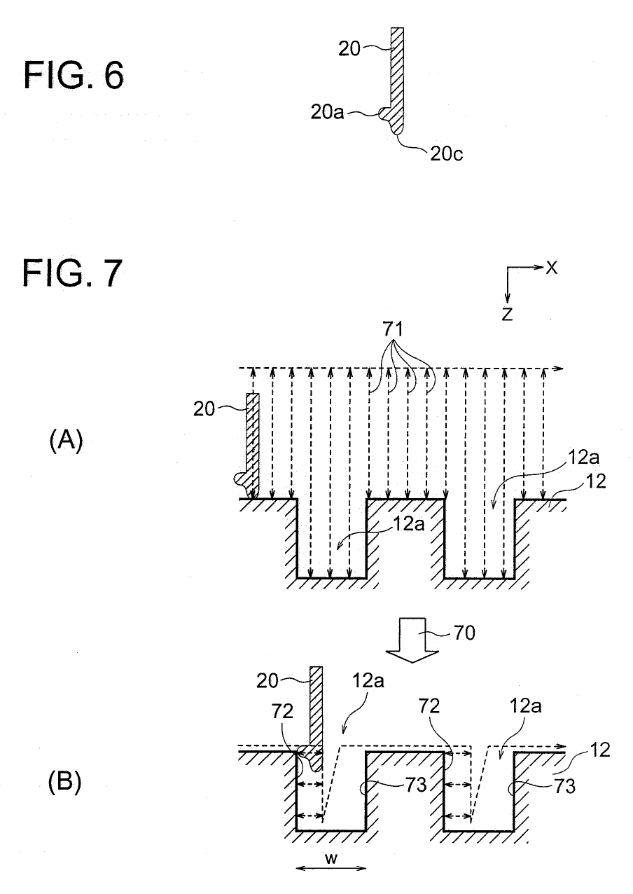

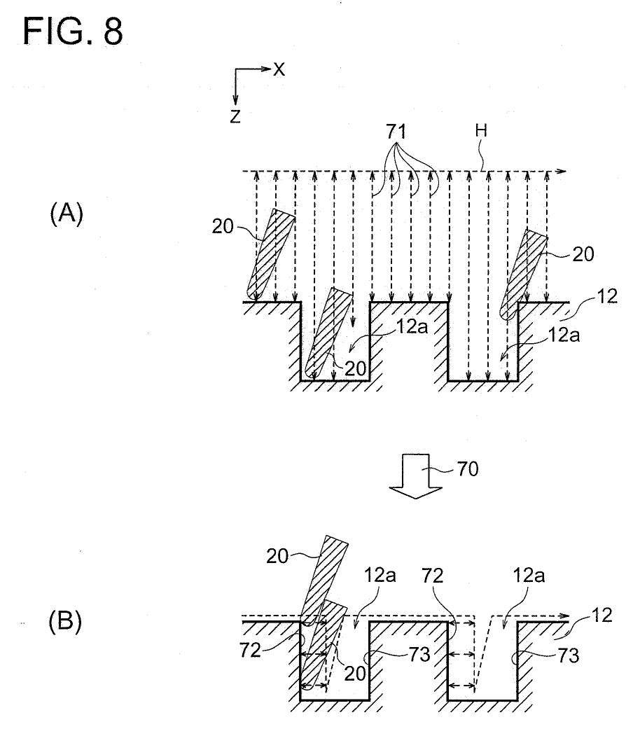

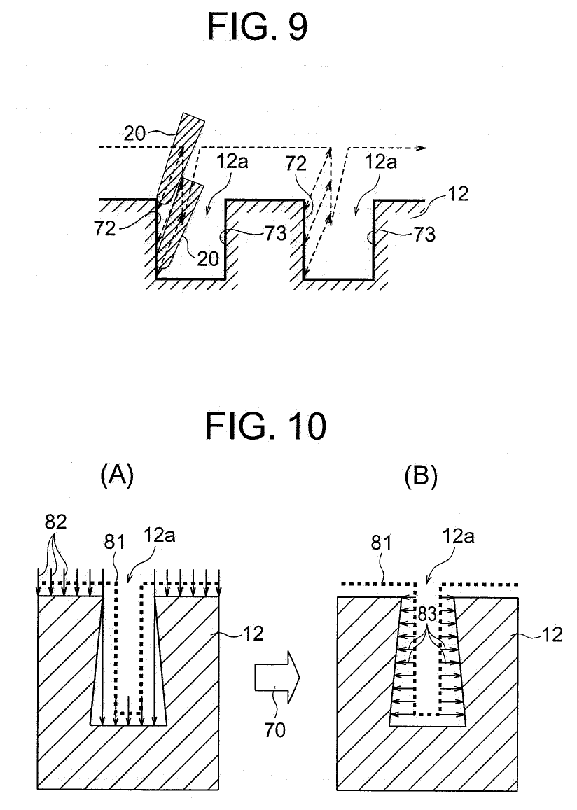

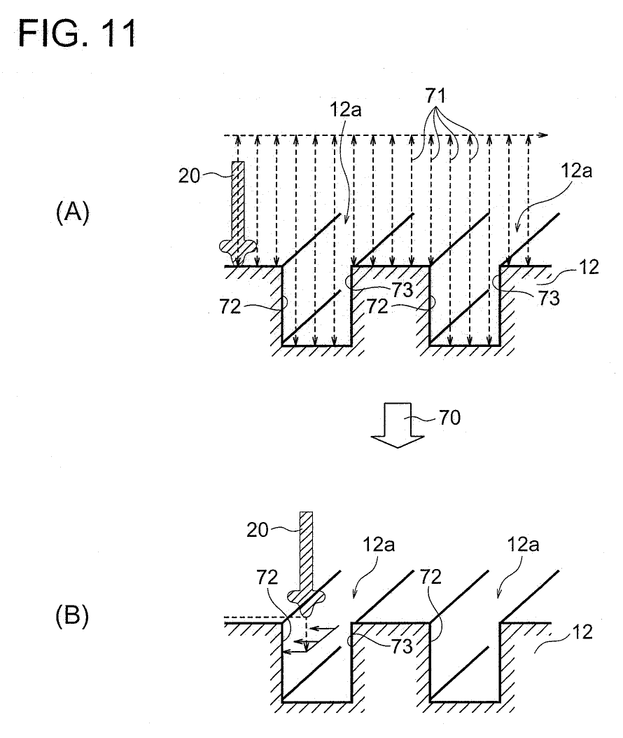

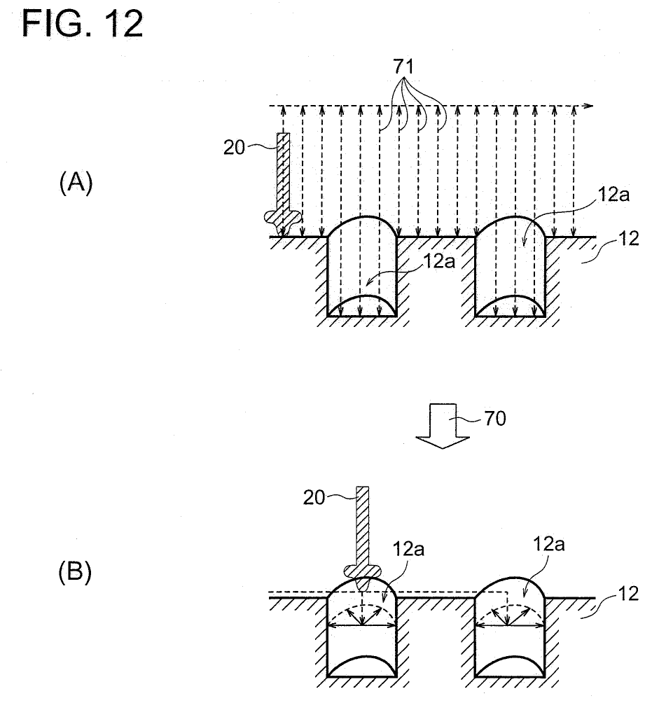

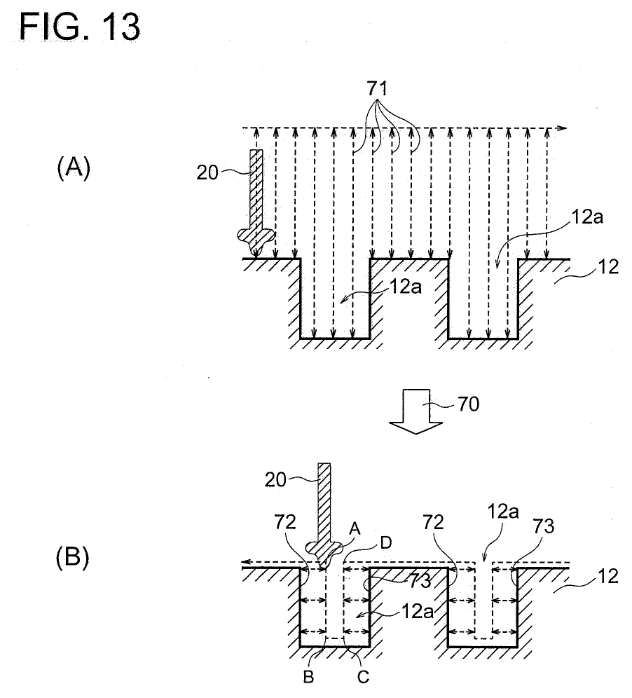

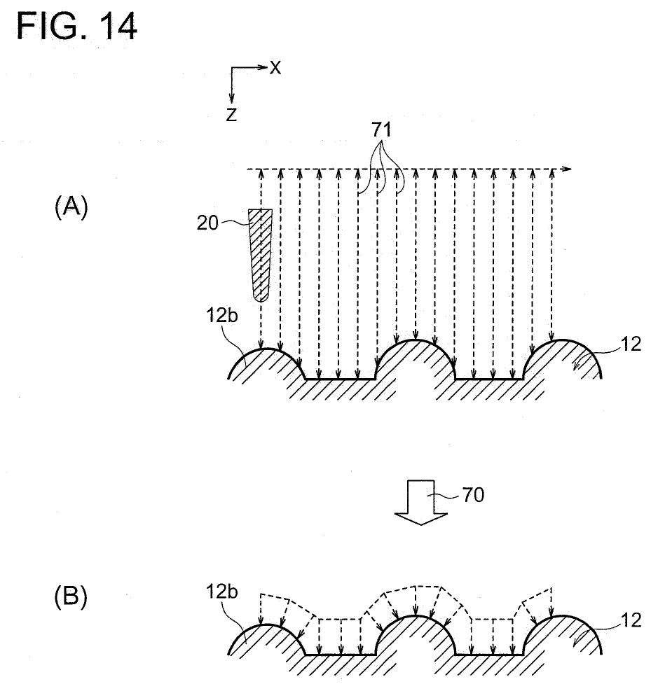

### BRIEF DESCRIPTION OF THE DRAWINGS

[FIG. 1] A composition view showing the whole configuration of a scanning probe microscope of the present invention.

[FIG. 2] A front view showing a shape of the probe used for the measuring method of the present invention.

[FIGS. 3A-3B] Views showing a movement state of the probe in the first embodiment of the measuring method of the present invention.

[FIG. 4] A flowchart showing the first embodiment of the measuring method of the present invention.

[FIGS. 5A-5B] Views showing a movement state of the probe in the second embodiment of the measuring method of the present invention.

[FIG. 6] A front view showing a shape of another probe used in the measuring method of the present invention.

[FIGS. 7A-7B] Views showing a movement state of the probe in the third embodiment of the measuring method of the present invention.

[FIGS. 8A-8B] Views showing a movement state of the probe in the fourth embodiment of the measuring method of the present invention.

[FIG. 9] A view showing a movement state of the probe in the modification of the fourth embodiment of the measuring method of the present invention.

[FIGS. 10A-10B] Views showing a movement state of the probe in the fifth embodiment of the measuring method of the present invention.

[FIGS. 11A-11B] Views showing a movement state of the probe in the sixth embodiment of the measuring method of the present invention.

[FIGS. 12A-12B] Views showing a movement state of the probe in the seventh embodiment of the measuring method of the present invention.

[FIGS. 13A-13B] Views showing a movement state of the probe in the eighth embodiment of the measuring method of the present invention.

[FIGS. 14A-14B] Views showing a movement state of the probe in the ninth embodiment of the measuring method of the present invention.

[FIGS. 15A-15C] Views showing a movement state of the probe for explaining the conventional measuring method of the conventional scanning probe microscope.

### THE MERITORIOUS EFFECTS OF THE INVENTION

This invention has the following meritorious effects. Since a scanning movement is performed two times by dividing the whole scanning movement into a scanning movement based on a Z direction control and a scanning movement of horizontal direction measurement, wear in the end tip of the probe can be decreased, measuring reliability can be improved, movement control of the probe scanning can be simplified, and scanning time cab be shortened when measuring slopes or side walls, etc. such as fine trenches and holes, etc. on the sample surface.

Moreover, in accordance with the scanning probe microscope and its measurement method of the present invention, since the two-dimensional following control executed when performing the scanning movement along both of side walls of trenches and the like on the sample surface is unnecessary, the measurement time is reduced. Further, in case that the horizontal size in a section between both side walls in trenches and the like is required, it is sufficient to measure only one point concerning the horizontal size, and therefore methods of use are not restricted in comparison with the conventional methods and the measurement of short time and high precision can be carried out. In addition, since the method of this invention does not include a lateral direction vibration required for the continuous tracing control, it is advantageous to the conventional methods when measuring the fine trenches or holes and the like.

### BEST MODE FOR EMBODYING THE INVENTION

Hereinafter, preferred embodiments of the present invention will be described referring to the attached figures.

The structure and basic operation of a scanning probe microscope of the embodiment of the present invention are explained with reference to FIG. 1. This scanning probe microscope is an atomic force microscope (AFM) as a typical example.

A sample stage 11 is disposed in the lower section of the scanning probe microscope. A sample 12 is placed on the sample stage 11. The sample stage 11 has a mechanism for changing the position of the sample 12 in the three-dimensional coordinate system 13 composed of X-axis, Y-axis and Z-axis that intersect perpendicularly. The sample stage 11 is comprised of a XY stage 14, a Z stage 15 and a sample holder 16. The sample stage 11 is usually comprised as a coarse mechanism section for causing displacement (positional change) at a sample side. The above-mentioned sample 12 with a relatively large area and thin plate shape is disposed on the upper surface of the sample holder 16 in the sample stage 11 and further hold on the upper surface. The sample is, for example, a substrate or wafer on the surface of which integrated circuit patterns of semiconductor devices are made. The sample 12 is fixed on the sample holder 16. The sample holder 16 has a chuck mechanism for fixing the sample.

An optical microscope 18 with a drive mechanism 17 is disposed at a position above the sample 12. The optical microscope 18 is supported by the drive mechanism 17. The drive mechanism 17 is comprised of a focus-use Z-direction actuator for moving the optical microscope 18 in a Z-axis direction and a XY-direction actuator for moving it in a XY-axis direction. The drive mechanism 17 is fixed to a frame member. However, the illustration of the frame member is omitted in FIG. 1.

The optical microscope 18 with an object lens 18a being directed downward is arranged at an upper position to face the surface of the sample 12 from directly above. A TV camera (imaging unit) 19 is attached to the top end of the optical microscope 18. The TV camera 19 takes an image of a specific region in the sample surface obtained through the object lens 18a and outputs data of the image.

A cantilever 21 with a probe 20 at a tip thereof is arranged at a position above the sample 12 so as to make an approach to the sample surface. The cantilever 21 is fixed to a mount 22. The mount 22 is provided with an air suction part (no shown) for example, which is connected to an air suction device (not shown). A base member with a large area in the cantilever 21 is sucked by the air suction part of the mount 22 and thereby the cantilever 21 is attached to the mount 22. The mount 22 is provided with a projected section 23 at the rear thereof.

The above-mentioned mount 22 is attached to the undersurface of a support frame 25 for supporting a cantilever displacement detection section 24.

The cantilever displacement detection section 24 is configured so that a laser light source 26 and a photo detector 27 are attached to the support frame 25 in accordance with a predetermined arrangement relationship. The cantilever displacement detection section 24 and the cantilever 21 are held in a constant positional relationship and a laser beam 28 emitted from the laser light source 26 is reflected at the rear of the cantilever 21 so as to enter the photo detector 27. The cantilever displacement section 24 forms an optical lever type photo detection device. When the formation such as torsion, flexure, etc. is generated in the cantilever 21, the optical lever type photo detection device can detect the displacement due to the formation.

The cantilever displacement detection section 24 is attached to an XYZ fine movement mechanism 29. The XYZ fine movement mechanism 29 moves the cantilever 21 with the probe 20 in each of X, Y and Z directions in a fine distance. In this time, the cantilever displacement detection section 24 is simultaneously moved together with the cantilever 21 and the positional relationship between the cantilever 21 and the cantilever displacement detection section 24 is unchanged.

In the above configuration, the XYZ fine movement mechanism 29 is constructed by a parallel plate-spring mechanism including piezoelectric elements, a tube type mechanism, or a voice coil motor, etc. The XYZ fine movement mechanism 29 causes the probe 20 to be displaced in each of X-axis, Y-axis and Z-axis directions in a fine distance (for example, several mm to 10 mm and a maximum of 100 mm).

The above XYZ fine movement mechanism 29 is attached to the above-mentioned frame member 30 to which the unit including the optical microscope 18 is attached.

In accordance with the positional relationship based on the attachment, the specific region on the surface of the sample 12 and the tip part (back part) of the cantilever 21 having the probe 20 can be observed through the optical microscope 18 and shown in an observation field thereof.

Moreover, the projected section 23 of the above mount 22 is provided with a high-precision X-axis direction displacement detector 31, a high-precision Y-axis direction displacement detector 32, and a high-precision Z-axis direction displacement detector 33. As the displacement detectors 31-33, a displacement detector of an electrostatic capacity type, a differential transformer type, or a laser interferometer type is used.

Next, the control system of the scanning probe microscope will be explained. The control system has an AFM system controller 40 that is essentially consisted of computers.

The AFM system controller 40 has an optical microscope control section 41, a shape measurement section 42, a comparison section (or subtraction section) 43, a control section 44, an XYZ instruction section 45, an XYZ drive section 46, an XYZ stage control section 47, and a memory section 48 as functional sections therein. Further, a display device 52 and an input device 53 are arranged to the AFM system controller 40 through the interface section 51.

The comparison section 43 and the control section 44 are used for realizing the measurement mechanism of the atomic force microscope (AFM) in principle. The comparison section 43 compares the Z-direction flexure voltage signal Va outputted from the photo detector 27 with a reference voltage (Vref) set in advance and outputs a deviation signal s1. The control section 44 produces a control signal s2 so that the deviation signal s1 may come to be zero, and supplies the control signal s2 to a terminal 61a of a switching section 61 in the XYZ drive section 46.

Moreover, the torsion voltage signal Vb among signals outputted from the photo detector 27 enters into the shape measurement section 42.

A four divisional type photo-diode, etc. is used for the above-mentioned photo detector 27. The photo detector 27 outputs the above-mentioned flexure voltage signal Va and torsion voltage signal Vb concerning the cantilever 21.

The drive mechanism 17 comprising the focus-use Z-direction actuator and the XY-direction actuator changes the position of the optical microscope 18. The above optical microscope control section 41 controls the operation of the drive mechanism 17 comprising the focus-use Z-direction actuator and the XY-direction actuator.

The TV camera 19 takes the image of the sample surface or the cantilever 2 obtained by the optical microscope 18 and outputs the data of the image. The image data obtained by the TV camera 19 of the optical microscope 18 is processed in the optical microscope control section 41.

The above-mentioned XYZ instruction section 45 outputs signals (finally Vx, Vy, Vz) for instructing the amounts of X direction fine movement, Y direction fine movement and Z direction fine movement of the XYZ fine movement mechanism 29. The signal concerning the amount of Z direction fine movement outputted from the XYZ instruction section 45 is supplied to a terminal 61b of the switching section 61 of the XYZ drive section 46. A movable terminal 61c of the switching section 61 is alternatively connected to the above terminal 61a or terminal 61b. The signal outputted from the movable terminal 61c of the switching section 61 is given to the Z fine movement section of the XYZ fine movement mechanism 29 as a signal Vz via a control amplifier 62. Moreover, the signal concerning the amount of X direction fine movement outputted from the XYZ instruction section 45 is given to the X fine movement section of the XYZ fine movement mechanism 29 as a signal Vx via a control amplifier 63 of the XYZ drive section 46. Furthermore, the signal concerning the amount of Y direction fine movement outputted from the XYZ instruction section 45 is given to the Y fine movement section of the XYZ fine movement mechanism 29 as a signal Vy via a control amplifier 64 of the XYZ drive section 46.

A detection signal Uz from the Z-axis direction displacement detector 33 is inputted into the control amplifier 62, a detection signal Ux from the X-axis direction displacement detector 31 is inputted into the control amplifier 63, and a detection signal Uy from the Y-axis direction displacement detector 32 is inputted into the control amplifier 64. Each of the signals Ux, Uy and Uz from X-axis, Y-axis and Z-axis displacement detectors 31, 32 and 33 is also supplied to the memory section 48 and memorized therein as the displacement data of each direction.

It is constituted so that required data on the control may be exchanged among the shape measurement section 42, the XYZ instruction section 45 and the memory section 48.

Moreover, the XYZ stage control section 47 outputs the signals Sx, Sy and Sz, and thereby controls each operation of the XY stage 14 and Z stage 15 in the sample stage 11.

In the above-mentioned configuration, when connecting the movable terminal 61c of the switching section 61 with the terminal 61a, the XYZ fine movement mechanism 29 receiving the signal (Vz) based on the control signal s2 adjusts the height position of the cantilever 21 and maintains the distance between the probe 20 and the surface of the sample 12 at the fixed distance determined by the reference voltage (Vref). When scanning the sample surface by the probe 20, the control loop from the photo detector 27 to the XYZ fine movement mechanism 29 about Z direction flexure voltage signal Va is a feedback servo-control loop for holding the distance between the probe 20 and the sample 12 in a predetermined constant distance determined by the reference voltage (Vref), while detecting the deformation of the cantilever 21 by the optical lever-type photo detector. Usually, if the probe 20 is maintained at the fixed distance from the surface of the sample 12 by the control loop and the surface of the sample 12 is scanned in this state, the uneven shape of the sample surface can be measured.

In the above-mentioned feedback servo control loop containing the comparison section 43 and the control section 44 and the like, the control signal (s2) outputted from the control section 44 means the height signal of the probe 20 in the scanning probe microscope (atomic force microscope).

The scanning movement of the probe is performed on the measurement region in the surface of the sample 12 by operating the X fine movement section and Y fine movement section of the XYZ fine movement mechanism 29. The XYZ instruction section 45 controls the XYZ fine movement mechanism 29 using the X direction signals Vx and the Y direction signal Vy.

The memory section 48 stores the usual measurement programs and measurement conditions, the measurement program for executing the measuring method of the present embodiments, and measurement data, etc. Especially, in case of the present invention, the measurement program includes a component of the measurement process for moving the probe to sidewalls or inclination parts, etc., such as trenches or holes formed on the sample surface in the automatic measurement. Thus, the memory section 48 memorizes the program for measuring the sidewalls, etc.

Moreover, the AFM system controller 40 can display measurement images on the display device 52 based on the measurement data supplied to it through the interface section 51, and further can set up or change measurement programs, measurement conditions, or data, etc. through the input device 53.

Next, the measuring method performed under the scanning probe microscope with the above-mentioned composition will be explained. With reference to FIGS. 2 to 4, a first embodiment of the present invention is explained first.

FIG. 2 shows an example of the tip shape of the probe 20 used in the present embodiment. This example is illustrated to exaggerate the tip shape of the probe seen from the front. In FIG. 2, for example, the probe 20 has acute parts 20a and 20b to the horizontal direction (XY direction) in FIG. 1 parallel to the surface of the sample 12, and further has an acute part 20c to perpendicular direction (Z direction or height direction) crossing at right angles with the sample surface.

Next, FIG. 3 shows locus figures of movement of the probe 20. The locus figures (A) and (B) about two different movement operations are shown in FIG. 3. In accordance with the measuring method by this scanning probe microscope, it is premised that the operation of the measurements is carried out two times. In FIG. 3, (A) shows the movement locus of the probe by the first time measurement and (B) shows the movement locus of the probe by the second time measurement. An arrow 70 from (A) to (B) means the order of the measurement.

In FIG. 3 (A), the probe 20 is moved to approach to and contact with the surface of the sample 12 at measurement points set up at the constant intervals while performing the scanning operation of the probe 20 from the left-hand side to right-hand side in the X direction in the figure. This movement method corresponds to the measuring method based on the discrete method explained in the part of the background technology. When the probe 20 carries out the scanning movement in the X direction, the tip position of the probe 20 is set as a fixed height position (H), and the probe 20 approaches to the sample surface only at each of the measurement points. In FIG. 3, many dotted lines 71 directed to the Z direction show the approach movements to the sample surface and the separation movements from the sample surface. In addition, for example, trenches 12a shall be formed in the surface of the sample 12 at the fixed interval. Therefore, the length of the dotted lines 71 differs at the surface of the sample 12 and the bottom of the trenches 12a. In addition, instead of the trenches 12a hollows 12a such as holes may be applied.

As shown in (A) of FIG. 3, on the basis of the instruction signal outputted from the XYZ instruction section 45 in the scanning of the first time, the uneven shape on the surface of the sample 12 is measured by the discrete method concerning a certain region including the measuring points. At this time, the movable terminal 61c is connected to the terminal 61a in the switching section 61. The displacement detectors 31-33 detect the positional coordinates concerning the movement locus obtained in the first time measurement and data of the uneven shape of the sample surface, and the memory section 48 memorizes them. Next, the measurement of the second time should be carried out as shown in (B) of FIG. 3. The movement direction in the second time scanning movement is identical to that in the first time scanning movement. In this case of the second time measurement, the positional coordinates concerning the sidewalls 72 and 73 in the trenches 12a and the like have been known by the first time measurement. Then, concerning the measurement of the sidewall 72, the scanning movement is switched so that the measurement is performed by the discrete method of the horizontal direction (X direction) in the interval from the point A to the point B along the surface of the sidewall 72. Also, concerning the measurement of another sidewall 73, the scanning movement is switched so that the measurement is performed by the discrete method of the horizontal direction (X direction) in the interval from the point C to the point D along the surface of the sidewall 73. The approach direction in case of measuring the sidewall 72 is opposite to the approach direction in case of measuring the sidewall 73.

In addition, in the measurement of the second time shown in (B) of FIG. 3, the discrete method in which the probe approaching/separating motion is performed in the X direction is applied only for the wall surface of the sidewalls 72 and 73 in the trench 12a and the like. Since the measurement data on the other sample surface of the sample 12 has already been obtained by the first time scanning movement, the measurement about the other sample surface is usually omitted in the second time measurement. Therefore, in (B) of FIG. 3, the second time measurement does not include the measurement by the discrete method in which the probe approaching/separating motion is performed in the Z direction.

By repeating the first time measurement and the second time measurement stated above, it becomes possible to measure correctly the shape of the sidewalls 72 and 73 as both sides in the trench 12a formed in the surface of the sample 12. Moreover, the whole time required for the measurement comes to be shortened. Although an example of one-line measurement has been explained in the above-mentioned embodiment, a surface can be also measured by repeating the one-line measurement.

Next, the twice measurement movements based on the above switching operation will be explained in detail with reference to the relation between the system configuration shown in FIG. 1 and the flowchart shown in FIG.

As mentioned above, the displacement signals (Ux, Uy, Uz) outputted from the high-precision displacement detectors 31-33 for the X-axis, the Y-axis and the Z-axis directions are respectively fed backed into the control amplifiers 62, 63 and 64 for each of the XYZ directions in the XYZ actuator 29. Although a mechanism using the piezoelectric elements is widely used as the XYZ fine movement mechanism 29, the non-linear operation of the piezoelectric elements can be compensated with the feedback of the detection signals outputted from the high-precision displacement detectors 31-33. In the measurement due to the scanning movement of the first time, the probe 20 is controlled to move in the Z direction by connecting the movable terminal 61c to the terminal 61a in the switching section 61 while scanning the probe in the XY direction (Step S1). The memory section 48 memorizes the result of the shape measurement due to the first time discrete method and the positional coordinates obtained then (Step S12).

In the second time measurement, position determination is carried out on the basis of the information stored in the memory section 48 (Step S13). At this step S13, the scanning locus (movement path) for the second time measurement is made and the control positions for measuring the horizontal direction components are made. When measuring the horizontal direction components by the discrete method along the wall surface of the wall sections 72 and 73 of the trenches 12a and the like, the control in the Z-axis direction as the atomic force microscope (AFM) caused to be off by connecting the movable terminal 61c to the terminal 61b in the switching section 61. When the probe would reach the measurement point for the measurement of the horizontal direction components, the XYZ fine movement mechanism 29 is operated to make movements in the horizontal direction (X or Y direction) and the positions of the probe 20 at which for example the torsion voltage signal Vb gets to a certain level are memorized in the memory section 48 (Step S14). The shape measuring section 42 makes shape information by composing the measurement value obtained by the first time measurement and the measurement value obtained by the second time measurement (Step S15). The shape information is displayed as images on the screen of the display device 52 through the interface section 51 (Step S16).

In accordance with the measuring method for the scanning probe microscope of the present embodiment, the shape information obtained by controlling the probe 20 in the Z direction and the shape information obtained by controlling the probe 20 in the horizontal direction (XY direction) can be measured separately, and the combination of the two shape information makes it possible to perform a true measurement concerning the sample surface and to perform the measurement in a short time. Further, the wear of the probe is extremely reduced because of the discrete method.

FIG. 5 shows the second embodiment of the measuring method for the scanning probe microscope of the present invention. FIG. 5 corresponds to FIG. 3 in the first embodiment and in FIG. 5 elements substantially identical to the elements illustrated in FIG. 3 are given with the same reference number respectively. The first time measurement shown in (A) of FIG. 5 is the same as what was explained by (A) of FIG. 3. In the second time measurement for measuring the horizontal direction component concerning the sidewalls 72 and 73 of the trenches 12 and the like shown in (B) of FIG. 5, only one point (E, F) is measured. This measuring method is effective in case that the horizontal size value on the one point (E, F) in the trenches 12a and the like is more necessary than the detailed information on the surface shape of the sidewalls 72 and 73.

In accordance with the measuring method of the second embodiment, the high reliability about the size measurement can be realized by calculating the mean value of the measured data obtained by some measurements repeatedly performed to the same spot, or by finely moving the probe in the vicinity of the points E and F. Moreover, according to the present embodiment, the measurement time can be further shortened, since the number of measurement points gets fewer.

In addition, in the measuring method of the second embodiment, although the scanning direction of the probe 20 in the second time measurement may be the same as the case of the first time measurement, it can be the opposite direction to be a return-side direction.

FIGS. 6 and 7 show the third embodiment of the measuring method of the scanning probe microscope of the present invention. FIG. 6 corresponds to FIG. 2 of the first embodiment and FIG. 7 corresponds to FIG. 3 of the first embodiment. In FIGS. 6 and 7, elements substantially identical to the elements explained in FIGS. 2 and 3 are given with the same reference numbers respectively. As shown in FIG. 6, the probe 20 of the scanning probe microscope has an acute part (20a) in the horizontal direction at only one side as the probe shape.

A scanning movement of the first time measurement shown in (A) of FIG. 7 is the same as that shown in (A) of FIG. 3. In the horizontal direction component measurement in the second time measurement concerning the sidewalls of the trenches 12a and the like shown in (B) of FIG. 7, only a left-side sidewall 72 is measured by the discrete method. This measuring method comes to be effective in a case that the shape of the sidewall is observed in a detail, a short-time measurement is required, or the width of the trench (hole diameter) W is minute.

FIGS. 8 and 9 show the fourth embodiment of the measuring method of the scanning probe microscope of the present invention. FIG. 8 corresponds to FIG. 3 of the first embodiment and FIG. 9 shows the modification of the fourth embodiment. In FIGS. 8 and 9, elements substantially identical to the elements explained in FIG. 3 are given with the same reference numbers respectively. The probe 20 used in the fourth embodiment is the same as the conventional probe, and only the tip thereof is acute, and it does not have the special acute parts (20a etc.) shown in the first embodiment.

As shown in (A) etc. of FIG. 8, the probe 20 is in the state that it is made to incline. In the first time measurement due to the discrete method shown in (A) of FIG. 8, the probe 20 is controlled to move only in the Z directions while performing the scanning movement in the X direction. The second time measurement shown in (B) of FIG. 8 shows the case where the probe 20 of an inclination state to the side wall 72 on the left-side in the trench 12a etc. of the sample 12. Although the system using the inclined probe 20 is elaborate technology, it can be used effectively in the sidewall measurement in a series of algorithm of the present invention.

Moreover, as shown in FIG. 9, the measurement operation of the horizontal direction component to the sidewall 72 of the trench, etc. 12a can be changed into the operation along the direction of the axis of the probe 20.

Measurement of the sidewall 72 can be attained only by making the probe 20 incline, without using the probe 20 with complicated shape in accordance with the measuring method of the fourth embodiment.

FIG. 10 shows the fifth embodiment of the measuring method of the scanning probe microscope of the present the invention. In FIG. 10, (A) shows the first time measurement and (B) shows the second time measurement. FIG. 10 is basically the same as FIG. 3 of the first embodiment. In FIG. 10, components identical to the components explained in FIG. 3 are given with the same reference numbers. The probe 20 used for the fifth embodiment is the same as the probe used in the first embodiment. The illustration of the probe 20 is omitted in FIG. 10.

The fifth embodiment shown in FIG. 10 indicates an example of measuring the trenches 12a, etc. formed on the surface of the sample 12, whose width becomes gradually wider as the depth thereof gets deeper. Even if the measurement is applied to the surface of the sidewall of the both sides of such the trenches 12a, etc., the measuring method of the embodiment makes the measurement possible easily. However, in accordance with this measurement, in the first time measurement shown by (A), the height of the probe 20 is set to be constant from the surface of the sample 12 and the bottom surface of the trenches 12a, etc. In FIG. 10, a dotted line 81 shows the movement locus (movement path) of the probe 20, and arrows 82 and 83 show an approaching movement of the probe 20.

FIG. 11 shows the sixth embodiment of the measuring method of the scanning probe microscope of the present invention. FIG. 11 is the same as FIG. 3, and (A) thereof shows the first time measurement and (B) thereof shows the second time measurement. In FIG. 11, components identical to the components explained in FIG. 3 are respectively given with the same reference numbers. The probe 20 used in the fifth embodiment is as same as the probe used in the first embodiment.

In accordance with the measuring method of the sixth embodiment, the measurement operation in the second time measurement is changed to a mode of performing the measurement along the sidewall 72 of the trench 12 in the length direction thereof. The measuring method of the present embodiment enables to measure the shape of the sidewall 72 (73) along its length direction.

FIG. 12 shows the seventh embodiment of the measuring method of the scanning probe microscope of the present invention. FIG. 12 corresponds to FIG. 3 and (A) shows the first time measurement and (B) shows the second time measurement. In FIG. 12, components identical to the components explained in FIG. 3 are respectively given with the same reference numbers. The probe 20 used in the seventh embodiment is the same as the probe used in the first time embodiment.

In accordance with the measuring method of the seventh embodiment, this method is applied to the case in which the shape formed on the surface of the sample 12 is a hole 12a. The first time measurement is the same as that explained in the first embodiment. On the other hand, the probe 20 is moved in the circumference direction of the hole 12a to measure the shape of the hole 12a.

FIG. 13 shows the eighth embodiment of the measuring method of the scanning probe microscope of the present invention. FIG. 13 corresponds to FIG. 3, and (A) shows the first time measurement and (B) shows the second time measurement. In FIG. 13, components identical to the components explained in FIG. 3 are respectively given with the same reference numbers. In the measurement of this embodiment, the scanning movement is performed to the direction of going side (a path for going forth) in the first time measurement, while the scanning movement is performed to the direction of returning side (a path for coming back) in the second time measurement. The measuring method of the eighth embodiment can make the scanning time reduced by half.

FIG. 14 shows the ninth embodiment of the measuring method of the scanning probe microscope of the present invention. FIG. 14 corresponds to FIG. 3, and (A) shows the first time measurement and (B) shows the second time measurement. In FIG. 14, components identical to the components explained in FIG. 3 are respectively given with the same reference numbers. In accordance with the measuring method of this embodiment, it is made to use the usual probe without the special tip part as the probe 20. This measuring method shows the case in which a plurality of projections 12b of a curved shape is formed on the surface of the sample 12. In the first time measurement, as shown in (A) of FIG. 14, the surface shape of the sample is drawn as a curve. In the second time measurement, the scanning movement is controlled to perform the measurement in a normal direction of the curved projection 12b on the surface of the sample 12 of the curved shape. The measuring method of the ninth embodiment enables a high-precision measurement, because there is no lateral force between the probe 20 and the sample 12 and therefore a sliding phenomenon etc. between them can be reduced.

In the measuring method of the ninth embodiment, the approaching movement of the probe 20 toward the normal direction against the curved projection 12b on the surface of the sample 12 is performed by the combination of the instruction signals of X and Z directions outputted from the XYZ instruction section 45. The horizontal component of X direction is included in the scanning operation due to the continuous method on the curved projection 12b.

In addition, although the atomic force microscope was explained typically in the above-mentioned embodiments, it is clear that the present invention is applicable to various scanning probe microscopes including a scanning tunneling microscope. Moreover, although the first time and second time measurements were explained using the discrete method, it is clear that the continuous method may be used and various kinds of modification is also possible by the combination of the both methods together with using the various shapes of the probe.

Moreover, although it was made to explain the case where the measurement movement of the second time measurement (FIG. 2(B), FIG. 5(B), etc.) is carried out horizontally, it may be made to move the probe in the slanting direction, as shown in FIG. 9, to detect the contact of the probe onto the sample surface using both the torsion signal and the flexure signal concerning the cantilever.

Further, when measuring the trench shape and the like, it is also possible to perform such measurement that the first time measurement is performed in only one line directed to the X direction while the measurements in plural lines are performed by shifting the probe in the Y direction concerning the second time measurement.

Furthermore, in the first time measurement, the measurement action may be operated at only one point or several points to be very few in a scanning line instead of along a continuous region or at regular intervals in the scanning line. For example, concerning the measurement shown in FIG. 9, the first time measurement is performed at one point or several points in order to measure the height of the sample surface and define a straight line based on the measured height, and the second time measurement may be performed so that the slanted probe is moved in a slanting direction from the straight line on the whole sample region along the straight line.

Moreover, in the above explanation, the displacement detection of the cantilever was made using the optical lever type photo detection method. However, it is also possible to use the system utilizing the piezo-resistance effect capable of detecting twisted state and bended state of the cantilever simultaneously.

Moreover, although the above-mentioned measuring method was explained about only sample shape measurement, it is also applicable to the measurement of the probe shape by performing the second time measurement against a sample with an edge in the vicinity of the edge, for example.

### INDUSTRIAL AVAILABILITY

The present invention is used for measuring correctly sidewalls and the like of the trenches, etc. on the sample surface for a short time when measuring the sample surface by the scanning probe microscope.

1. A measuring method of a scanning probe microscope provided with a cantilever with a probe which is opposite to a sample, a XYZ fine movement mechanism for making displacement in each direction of three axes (two axes X and Y parallel to a sample surface, and an axis Z of a height direction to the sample surface) which intersect perpendicularly in a positional relationship between said probe and said sample, a movement mechanism for changing a relative position of said probe and said sample, a measurement means for measuring surface properties of said sample based on the physical amount generated between said probe and said sample when making said probe scan the surface of said sample, and a displacement detection means for detecting the displacement of said cantilever, wherein surface characteristic of said sample is measured by making said probe scan the surface of said sample while holding said physical amount to be constant, the measuring method characterized in comprising,
a first step of performing a first time scanning movement of said probe in both or either of X and Y directions along a surface of said sample while controlling the position of said probe in a Z direction on said sample according to a predetermined probe movement path by said movement mechanism and said XYZ fine movement mechanisms,
a second step of obtaining measuring information about the surface of said sample by said measurement means and said displacement detection means during said first step,
a third step of determining a probe movement path for a second time scanning and a measuring spot in which a measurement including a parallel direction component to the surface of said sample is performed on said probe movement path, on the basis of said measuring information about the surface of said sample obtained in said second step, and
a fourth step of performing the measurement including the parallel direction component based on said second time scanning.

2. A measuring method of a scanning probe microscope as set forth in claim 1, characterized in that said measuring spot in which the measurement including the parallel direction component to the surface of said sample is performed has a spot having a slope on the surface of said sample.

3. A measuring method of a scanning probe microscope as set forth in claim 1, characterized in that said probe is separated from the surface of said sample in an area except for the measuring spot in the surface of said sample in said probe movement path based on the scanning movement.

4. A measuring method of a scanning probe microscope as set forth in claim 1, characterized in that said probe has pointed ends directed to both or either of parallel and perpendicular directions to the surface of said sample.

5. A measuring method of a scanning probe microscope as set forth in claim 1, characterized in that said probe is disposed so that an axis of said probe is inclined to the surface of said sample.

6. A measuring method of a scanning probe microscope as set forth in claim 1, characterized in that the measurement including the parallel direction component to the surface of said sample in said fourth step is performed at one measuring point at least or required minimum measuring points, in which size measurement is required.

7. A measuring method of a scanning probe microscope as set forth in claim 1, characterized in that the measurement including the parallel direction component to the surface of said sample uses a torsion signal generated when said cantilever is twisted.

8. A measuring method of a scanning probe microscope as set forth in claim 1, characterized in that, when the surface of said sample is formed to have trenches, the measurement including the parallel direction component to the surface of said sample in said fourth step is performed to be parallel to the trenches.

9. A measuring method of a scanning probe microscope as set forth in claim 1, characterized in that, when the surface of said sample is formed to have holes, the measurement including the parallel direction component to the surface of said sample in said fourth step is performed to be along a circumference direction of the holes.

10. A measuring method of a scanning probe microscope as set forth in claim 1, characterized in that, when performing said first step and said fourth step in a going and returning scanning movement, said first step is performed in the going path and said fourth step is performed in the returning path.

11. A measuring method of a scanning probe microscope as set forth in claim 1, characterized in that the scanning movement in said fourth step is performed against the surface of said sample, based on the measuring information about the surface of said sample obtained by said first and second steps so that a movement direction at each of measuring points is along a normal direction of the sample surface.

12. A measuring method of a scanning probe microscope as set forth in claim 1, characterized by providing a fifth step of composing the measurement information obtained by said second step and the measurement information obtained by said fourth step.

13. A measuring method of a scanning probe microscope as set forth in claim 1, characterized in that both or either of a torsion signal and a flexure signal in said cantilever is used for detecting contact between said probe and said sample in the measurement including the parallel direction component based on said fourth step.

14. A measuring method of a scanning probe microscope as set forth in claim 1, characterized in that a first scanning performed in said first step is one line scanning of X direction (or Y direction), and a probe movement path and a measurement spot determined in said third step is made by repeatedly shifting a probe movement path and a measurement spot determined on the basis of information obtained by said second step to the Y direction (or X direction).

15. A measuring method of a scanning probe microscope as set forth in claim 1, characterized in that one point or several points are selected as points for obtaining measurement information during the first scanning in said second step, the probe movement path determined in said third step is a straight line determined by the measurement information obtained at said one point or several points, and the measurement including the parallel direction component to the sample surface in said fourth step is performed along the straight line.

16. A scanning probe microscope provided with a cantilever with a probe which is opposite to a sample, a XYZ fine movement mechanism for making displacement in each direction of three axes (two axes X and Y parallel to a sample surface, and an axis Z of a height direction to the sample surface) which intersect perpendicularly in a positional relationship between said probe and said sample, a movement mechanism for changing a relative position of said probe and said sample, a measurement means for measuring surface properties of said sample based on the physical amount generated between said probe and said sample when making said probe scan the surface of said sample, and a displacement detection means for detecting the displacement of said cantilever, and a control computer for changing a positional relationship between said probe and said sample by said XYZ fine movement mechanism and said movement mechanism, wherein surface characteristic of said sample is measured by making said probe scan the surface of said sample while holding said physical amount to be constant, the scanning probe microscope characterized in that said control computer is installed with a program for realizing,
a first function for performing a first time scanning movement of said probe in both or either of X and Y directions along a surface of said sample while controlling the position of said probe in a Z direction on said sample according to a predetermined probe movement path by said movement mechanism and said XYZ fine movement mechanism,
a second function for obtaining measuring information about the surface of said sample by said measurement means and said displacement detection means during said scanning,
a third function for determining a probe movement path for a second time scanning and a measuring spot in which a measurement including a parallel direction component to the surface of said sample is performed on said probe movement path, on the basis of said measuring information about the surface of said sample obtained in said measurement, and
a fourth function for performing the measurement including the parallel direction component based on said second time scanning.
